(19) United States
(12) Patent Application Publication
(10) Pub. No.: US 2003/0143413 A1
(43) Pub. Date: Jul. 31, 2003

(54) Producing pressure-sensitively adhesive punched products

(75) Inventors: Reinhard Storbeck, Hamburg (DE); Marc Husemann, Hamburg (DE); Matthias Koch, Hamburg (DE); Maren Klose, Seevetal (DE)

Correspondence Address: KURT BRISCOE, NORRIS, MCLAUGHLIN & MARCUS, P.A., 220 EAST 42ND STREET, 30TH FLOOR, NEW YORK, NY, 10017, US

(73) Assignee: tesa Aktiengesellschaft

(21) Appl. No.: 10/219,523

(22) Filed: Aug. 15, 2002

(30) Foreign Application Priority Data
Nov. 22, 2001 (DE) 101 57 153.4

(51) Int. Cl. B32B 27/00; B32B 27/30

(52) U.S. Cl. 428/500; 428/522

(57) ABSTRACT

A process for producing pressure-sensitively adhesive punched products from backing material coated with pressure sensitive adhesive, wherein

said pressure sensitive adhesive is oriented such that it possesses a preferential direction and,

the punching process is carried out continuously.

The invention relates to a process for producing punched products and to punched products thus obtainable.

All presently known pressure sensitive adhesives (PSAs) are characterized by a more or less pronounced flow behavior. When strongly pronounced, this flow behavior is also known as the cold flow or bleeding of a PSA. This inherent behavior of a PSA leads to problems when punching self-adhesive materials. The two common punching methods, flatbed punching and rotary punching, are affected by these problems. For example, punched products may be removed as well during matrix stripping, because the cold flow of a PSA does not allow clean separation of the adhesive. Where matrix stripping is carried out manually after the punching operation, as in Asia, for example, these problems are exacerbated, since the adhesive then has sufficient time available to coalesce.

A further problem arises in the kiss-cut process. In the kiss-cutting of self-adhesive materials, the release material is part-punched as well, i.e., the punching tools penetrate to a more or less defined depth into the substrate material (=release material). As a result, the antiadhesively finished surface of the release material (in the majority of cases, the release materials are siliconized; this applies to all release systems described; Satas, 3rd edition, chapters 26 and 27) is always destroyed. The adhesive is able to flow into the substrate material of the release material (paper, PET, PP, PE) and adhere. The punched product can no longer be removed readily from the siliconized release material, since the edges of the punched product are stuck to the substrate. In a downstream processing step, such as automatic dispensing, for example, the punched product or the matrix lattice surrounding the punched products and intended for removal may tear during stripping. Such tears nowadays cause massive disruptions to production. The effects described apply to all product structures, such as adhesive transfer tapes, and also to substrates coated on one or both sides, such as films, nonwovens, papers, lays or foams.

It is an object of the invention, therefore, to improve the production of punched products by avoiding, or else at least considerably reducing, the above-described disadvantages of the prior art.

Surprisingly and in a manner unforeseeable for the skilled worker, this object is achieved through the use of anisotropic pressure sensitive adhesives in the punching process. The main claim accordingly relates to a process for producing pressure sensitively adhesive punched products from backing material provided with a pressure sensitive adhesive, said pressure sensitive adhesive being anisotropic by virtue of possessing a preferential direction, and the punching process being carried out continuously. The subclaims relate to preferred developments of this process. Further claims relate to the punched products thus obtainable.

Pressure Sensitive Adhesives

Anisotropic pressure sensitive adhesives which can be employed for the inventive process are sometimes referred to below as anisotropically oriented, or simply as oriented, PSAs.

Anisotropically oriented PSAs possess the tendency to move back into the initial state following stretching in a given direction, as a result of their “entropy-elastic” behavior.

Suitable in principle for the inventive process are all PSAs which exhibit an orientation, examples being those based on natural or synthetic rubbers such as butyl rubber, neoprene, butadiene-acrylonitrile, styrene-butadiene-styrene copolymers and styrene-isoprene-styrene copolymers, and also those based on linear polyesters and copolyesters, polyurethanes, polysiloxane elastomers, based on acrylic block copolymers, especially those with diblocks and/or triblocks, in which at least one block component is based on polyacrylates, and, additionally, PSAs based on straight acrylics, but with very special advantage anisotropic PSAs based on polyacrylate and/or polymethacrylate.

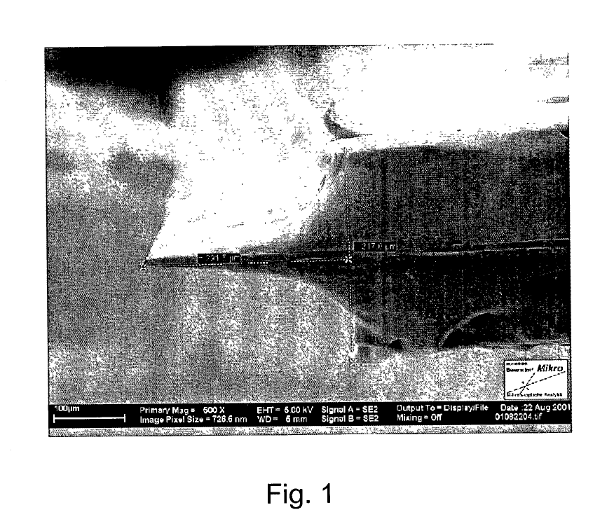

Surprisingly, in the form of a layer, anisotropically oriented acrylic PSAs of this kind exhibit resilience of the PSA film following punching and/or cutting operations, at the cut and punched edge, this recession being utilized inventively for the punching of shapes which do not flow together again (coalesce). This property is not known for any of the pressure sensitive adhesives which have hitherto belonged to the state of the art. (FIG. 1 shows one edge of a punched product of this kind following the punching process. The recession of the pressure sensitive adhesive, caused by anisotropic orientation, can be seen.)

The monomers are preferably chosen such that the resulting polymers can be used as pressure sensitive adhesives at room temperature or at higher temperatures, especially such that the resulting polymers possess pressure-sensitively adhering properties in accordance with the “Handbook of Pressure Sensitive Adhesive Technology” by Donatas Satas (van Nostrand, New York, 1989).

The polymers which can be used with preference for the inventive process are preferably obtainable by polymerizing a monomer mixture composed of acrylic esters and/or methacrylic esters and/or their free acids with the formula CH₂═CH(R₁)(COOR₂), where R₁═H or CH₃ and R₂ is an alkyl chain having 1-20 carbon atoms or H.

The molar masses M_{w} of the polyacrylates used are preferably ≧200 000 g/mol.

Very preferably, use is made for the inventive process of acrylic or methacrylic monomers composed of acrylates and methacrylates having alkyl groups of 4 to 14 carbon atoms, preferably from 4 to 9 carbon atoms. Specific examples, without wishing to be restricted by this listing, include methyl acrylate, methyl methacrylate, ethyl acrylate, n-butyl acrylate, n-butyl methacrylate, n-pentyl acrylate, n-hexyl acrylate, n-heptyl acrylate, n-octyl acrylate, n-octyl methacrylate, n-nonyl acrylate, lauryl acrylate, stearyl acrylate, behenyl acrylate, and the branched isomers thereof, such as isobutyl acrylate, 2-ethylhexyl acrylate, 2-ethylhexyl methacrylate, isooctyl acrylate, and isooctyl methacrylate, for example.

Further classes of compounds which can be used include monofunctional acrylates and methacrylates of bridged cycloalkyl alcohols, composed of at least 6 carbon atoms. The cycloalkyl alcohols may also be substituted, by C₁₋₆ alkyl groups, halogen atoms or cyano groups, for example. Specific examples include cyclohexyl methacrylates, isobornyl acrylate, isobornyl methacrylate and 3,5-dimethyladamantyl acrylate.

In one procedure monomers are used which carry polar groups such as carboxyl radicals, sulfonic and phosphonic acid, hydroxyl radicals, lactam and lactone, N-substituted amide, N-substituted amine, carbamate, epoxy, thiol, alkoxy, and cyano radicals, ethers or the like.

Examples of moderate basic monomers are N,N-dialkyl-substituted amides, such as N,N-dimethylacrylamide, N,N-dimethylmethacrylamide, N-tert-butylacrylamide, N-vinyl-pyrrolidone, N-vinyllactam, dimethylaminoethyl methacrylate, dimethylaminoethyl acrylate, diethylaminoethyl methacrylate, diethylaminoethyl acrylate, N-methylolmethacrylamide, N-(butoxymethyl)methacrylamide, N-methylolacrylamide, N-(ethoxymethyl)acrylamide, N-isopropylacrylamide, this list not being conclusive.

Further preferred examples are hydroxyethyl acrylate, hydroxypropyl acrylate, hydroxyethyl methacrylate, hydroxypropyl methacrylate, allyl alcohol, maleic anhydride, itaconic anhydride, itaconic acid, glyceridyl methacrylate, phenoxyethyl acrylate, phenoxyethyl methacrylate, 2-butoxyethyl methacrylate, 2-butoxyethyl acrylate, cyanoethyl methacrylate, cyanoethyl acrylate, glyceryl methacrylate, 6-hydroxyhexyl methacrylate, vinylacetic acid, tetrahydrofurfuryl acrylate, β-acryloyloxypropionic acid, trichloroacrylic acid, fumaric acid, crotonic acid, aconitic acid, dimethylacrylic acid, this list not being conclusive.

In another very preferred procedure, monomers used include vinyl esters, vinyl ethers, vinyl halides, vinylidene halides, and vinyl compounds with aromatic cycles and heterocycles in the α position. Here again, mention may be made nonexclusively of some examples: vinyl acetate, vinylformamide, vinylpyridine, ethyl vinyl ether, vinyl chloride, vinylidene chloride and acrylonitrile.

In another very preferred procedure, moreover, photoinitiators containing a copolymerizable double bond are used. Suitable photoinitiators include Norrish I and Norrish II photoinitiators. Examples are benzoin acrylate and an acrylated benzophenone from UCB (Ebecryl P 36®). In principle it is possible to copolymerize any photoinitiator which is known to the skilled worker and which is able to crosslink the polymer by a free-radical mechanism under UV irradiation. An overview of possible photoinitiators which can be used and which can be functionalized with a double bond is given in Fouassier: “Photoinitiation, Photopolymerization and Photocuring: Fundamentals and Applications”, Hanser-Verlag, Munich 1995. For further details, use is made of Carroy et al. in “Chemistry and Technology of UV and EB Formulation for Coatings, Inks and Paints”, Oldring (Ed.), 1994, SITA, London.

In another preferred procedure, monomers which possess a high static glass transition temperature are added to the comonomers described. Suitable components include aromatic vinyl compounds, such as styrene, in which case the aromatic nuclei are preferably composed of C₄ to C₁₈ units and may also contain heteroatoms. Particularly preferred examples include 4-vinylpyridine, N-vinylphthalimide, methylstyrene, 3,4-dimethoxystyrene, 4-vinylbenzoic acid, benzyl acrylate, benzyl methacrylate, phenyl acrylate, phenyl methacrylate, t-butylphenyl acrylate, t-butylphenyl methacrylate, 4-biphenyl acrylate and methacrylate, 2-naphthyl acrylate and methacrylate, and mixtures of those monomers, this list not being conclusive.

For the inventive process it is also possible to use oriented block copolymers based on acrylate and/or methacrylate. Here, mention may be made in particular, by way of example, of those pressure sensitive adhesives based on at least one block copolymer, the weight fractions of the block copolymers totaling at least 50% of the pressure sensitive adhesive, and at least one block copolymer being composed at least in part on the basis of (meth)acrylic acid derivatives, and additionally at least one block copolymer comprising at least the unit P(A)-P(B)-P(A) comprising at least one polymer block P(B) and at least two polymer blocks P(A), where

P(A) independently of one another represent homopolymer or copolymer blocks of monomers A, the polymer blocks P(A) each having a softening temperature in the range from +20° C. to +175° C.,

P(B) represents a homopolymer or copolymer block of monomers B, the polymer block P(B) having a softening temperature in the range from −130° C. to +10° C.,

the polymer blocks P(A) and P(B) are not homogeneously miscible with one another, and

the pressure sensitively adhesive system is oriented by virtue of possessing a preferential direction, the refractive index measured in the preferential direction, n_{MD}, being greater than the refractive index measured in a direction perpendicular to the preferential direction, n_{CD}.

In a very advantageous procedure, the inventive process uses an oriented pressure sensitive adhesive which exhibits shrinkback behavior, the shrinkback being at least 3% as determined by test B (shrinkback measurement in the free film). In a development of the inventive process, pressure sensitive adhesives are used in which the shrinkback is at least 30%, in one preferred embodiment at least 50%.

A feature of pressure sensitive adhesives used with preference is that the refractive index measured in the preferential direction, n_{VR}, is greater than the refractive index measured in a direction perpendicular to the preferential direction, n_{SR}. The refractive index n of a medium is given by the ratio of the speed of light in a vacuum, c₀, to the speed of light in the medium in question, c. Accordingly, n=c₀/c, n being a function of the wavelength of the light in question. A measure of the orientation of the pressure sensitive adhesive is the difference Δn between the refractive index n_{VR} measured in a preferential direction (stretching direction VR) and the refractive index n_{SR} measured in a direction (SR) perpendicular to the preferential direction. In other words, Δn=n_{VR}−n_{SR}, and this figure is obtainable by the measurements described in test C.

With great preference, in the pressure sensitive adhesives used for the inventive process, the difference Δn=n_{VR}−n_{SR} is at least 1·10⁻⁵.

In a further development, resins may be admixed to the polyacrylate PSAs. As tackifying resins for addition it is possible without exception to use any tackifier resins which are known and are described in the literature. As representatives, mention may be made of pinene resins, indene resins, and rosins, their disproportionated, hydrogenated, polymerized, esterified derivatives and salts, the aliphatic and aromatic hydrocarbon resins, terpene resins and terpene-phenolic resins, and also C5, C9, and other hydrocarbon resins. Any desired combinations of these and other resins may be used in order to adjust the properties of the resulting adhesive in accordance with what is desired. In general it is possible to use any resin which is compatible (soluble) with the corresponding polyacrylate; in particular, reference may be made to all aliphatic, aromatic, and alkylaromatic hydrocarbon resins, hydrocarbon resins based on pure monomers, hydrogenated hydrocarbon resins, functional hydrocarbon resins, and natural resins. Express reference is made to the depiction of the state of the art in the “Handbook of Pressure Sensitive Adhesive Technology” by Donatas Satas (van Nostrand, 1989).

Furthermore, it is also possible optionally to add plasticizers, fillers (e.g. fibers, carbon black, zinc oxide, titanium dioxide, chalk, solid or hollow glass beads, microbeads made of other materials, silica, silicates), nucleators, blowing agents, compounding agents and/or aging inhibitors, in the form for example of primary and secondary antioxidants or in the form of light stabilizers.

Additionally, crosslinkers and promoters for crosslinking may be admixed. Examples of suitable crosslinkers for electron beam crosslinking and UV crosslinking include difunctional or polyfunctional acrylates, difunctional or polyfunctional isocyanates (including those in blocked form), and difunctional or polyfunctional epoxides.

For optional crosslinking with UV light, UV-absorbing photoinitiators may be added to the polyacrylate PSAs. Useful photoinitiators which are very good to use include benzoin ethers, such as benzoin methyl ether and benzoin isopropyl ether, for example, substituted acetophenones, such as 2,2-diethoxyacetophenone (available as Irgacure 651® from Ciba Geigy®), 2,2-dimethoxy-2-phenyl-1-phenylethanone, dimethoxyhydroxyacetophenone, substituted α-ketols, such as 2-methoxy-2-hydroxypropiophenone, for example, aromatic sulfonyl chlorides, such as 2-naphthylsulfonyl chloride, for example, and photoactive oximes, such as 1-phenyl-1,2-propanedione 2-(O-ethoxycarbonyl)oxime.

The abovementioned photoinitiators and others which can be used, including those of the Norrish I or Norrish II type, may contain the following radicals: benzophenone, acetophenone, benzil, benzoin, hydroxyalkylphenone, phenyl cyclohexyl ketone, anthraquinone, trimethylbenzoylphosphine oxide, methylthiophenyl morpholine ketone, aminoketone, azobenzoin, thioxanthone, hexaarylbisimidazole, triazine, or fluorenone, it being possible for each of these radicals to be further substituted by one or more halogen atoms and/or one or more alkoxy groups and/or one or more amino groups or hydroxyl groups. A representative overview is given by Fouassier: “Photoinitiation, Photopolymerization and Photocuring: Fundamentals and Applications”, Hanser-Verlag, Munich 1995. For further details, it is possible to consult Carroy et al. in “Chemistry and Technology of UV and EB Formulation for Coatings, Inks and Paints”, Oldring (Ed.), 1994, SITA, London.

Preparation Processes for Pressure Sensitive Adhesives Used with Advantage

For polymerization the monomers are chosen such that the resulting polymers can be used as pressure sensitive adhesives at room temperature or higher temperatures, particularly such that the resulting polymers possess pressure sensitive adhesive properties in accordance with the “Handbook of Pressure Sensitive Adhesive Technology” by Donatas Satas (van Nostrand, New York, 1989).

In order to obtain a preferred polymer glass transition temperature T_{G}≦25° C., in accordance with the above remarks, the monomers are very preferably selected in such a way, and the quantitative composition of the monomer mixture advantageously chosen in such a way, that the polymer is obtained with the desired TG in accordance with the Fox equation (G1) (cf. T. G. Fox, Bull. Am. Phys. Soc. 1 (1956)123).

$$\frac{1}{{T}_{G}} = {\sum }_{n} \frac{{w}_{n}}{{T}_{G , n}} \qquad \text{(G1)}$$

In this equation, n represents the serial number of the monomers used, wₙ denotes the mass fraction of the respective monomer n (in % by weight) and T_{G,n} denotes the respective glass transition temperature of the homopolymer of the respective monomer n, in K.

In order to prepare the poly(meth)acrylate PSAs it is advantageous to carry out conventional radical polymerizations. For the polymerizations proceeding by a radical mechanism it is preferred to use initiator systems which additionally comprise further radical initiators for the polymerization, especially thermally decomposing, radical-forming azo or peroxo initiators. In principle, however, any customary initiators that are familiar to the skilled worker for acrylates are suitable. The production of C-centered radicals is described in Houben Weyl, Methoden der Organischen Chemie, Vol. E 19a, pp. 60-147. These methods are employed preferentially in analogy.

Examples of radical sources are peroxides, hydroperoxides, and azo compounds; some nonexclusive examples of typical radical initiators that may be mentioned here include potassium peroxodisulfate, dibenzoyl peroxide, cumene hydroperoxide, cyclohexanone peroxide, di-t-butyl peroxide, azodiisobutyronitrile, cyclohexylsulfonyl acetyl peroxide, diisopropyl percarbonate, t-butyl peroctoate, and benzpinacol. In one very preferred version, 1,1′-azobis(cyclohexanecarbonitrile) (Vazo 88™ from DuPont) or azodiisobutyronitrile (AIBN) is used as radical initiator.

The average molecular weights M_{w} of the pressure sensitive adhesives formed in the course of the radical polymerization are very preferably chosen such as to be situated within a range from 200 000 to 4 000 000 g/mol; specifically for further use as hotmelt pressure sensitive adhesives with anisotropic behavior, PSAs having average molecular weights M_{w} of from 400 000 to 1 400 000 g/mol are prepared. The average molecular weight is determined by size exclusion chromatography (GPC) or matrix-assisted laser desorption/ionization mass spectrometry (MALDI-MS).

The polymerization may be carried out in bulk, in the presence of one or more organic solvents, in the presence of water, or in mixtures of organic solvents and water. The aim is to minimize the amount of solvent used. Suitable organic solvents are pure alkanes (e.g., hexane, heptane, octane, isooctane), aromatic hydrocarbons (e.g., benzene, toluene, xylene), esters (e.g., ethyl, propyl, butyl or hexyl acetate), halogenated hydrocarbons (e.g., chlorobenzene), alkanols (e.g., methanol, ethanol, ethylene glycol, ethylene glycol monomethyl ether), and ethers (e.g., diethyl ether, dibutyl ether) or mixtures thereof. A water-miscible or hydrophilic cosolvent may be added to the aqueous polymerization reactions in order to ensure that in the course of monomer conversion the reaction mixture is in the form of a homogeneous phase. Cosolvents which can be used with advantage for the present invention are chosen from the following group, consisting of aliphatic alcohols, glycols, ethers, glycol ethers, pyrrolidines, N-alkylpyrrolidinones, N-alkylpyrrolidones, polyethylene glycols, polypropylene glycols, amides, carboxylic acids and salts thereof, esters, organosulfides, sulfoxides, sulfones, alcohol derivatives, hydroxy ether derivatives, amino alcohols, ketones, and the like, and also derivatives and mixtures thereof.

The polymerization time is between 2 and 72 hours, depending on conversion and temperature. The higher the reaction temperature can be chosen, i.e., the higher the thermal stability of the reaction mixture, the lower the reaction time.

For the initiators which undergo thermal decomposition, the introduction of heat is essential to initiate the polymerization. For the thermally decomposing initiators the polymerization can be initiated by heating at from 50 to 160° C., depending on initiator type.

For the preparation of acrylic hotmelt PSAs it may also be of advantage to polymerize the acrylic PSAs in bulk. It is particularly appropriate here to employ the prepolymerization technique. The polymerization is initiated with UV light but conducted only to a low conversion rate of about 10-30%. This polymer syrup can then be welded into films, for example (in the most simple case, ice cubes) and then polymerized in water to a high conversion rate. The resulting pellets can then be employed as acrylic hotmelt adhesives, the film materials used for the melting operation being, with particular preference, those which are compatible with the polyacrylate.

Another advantageous preparation process for the poly(meth)acrylate PSAs is anionic polymerization. In this case it is preferred to use inert solvents as the reaction medium, such as aliphatic and cycloaliphatic hydrocarbons, for example, or else aromatic hydrocarbons.

In this case the living polymer is generally represented by the structure P_{L}(A)-Me, in which Me is a metal from group I, such as lithium, sodium or potassium, and P_{L}(A) is a growing polymer block of the monomers A. The molar mass of the polymer to be prepared is controlled by the ratio of initiator concentration to monomer concentration. Examples of suitable polymerization initiators include n-propyllithium, n-butyllithium, sec-butyllithium, 2-naphthyllithium, cyclohexyllithium, and octyllithium, with this list making no claim to completeness. Furthermore, initiators based on samarium complexes are known for the polymerization of acrylates (Macromolecules, 1995, 28, 7886) and can be used here.

Moreover, it is also possible to use difunctional initiators, such as 1,1,4,4-tetraphenyl-1,4-dilithiobutane or 1,1,4,4-tetraphenyl-1,4-dilithioisobutane. Coinitiators may likewise be used. Suitable coinitiators include lithium halides, alkali metal alkoxides or alkylaluminum compounds. In one very preferred version the ligands and coinitiators are chosen such that acrylic monomers, such as n-butyl acrylate and 2-ethylhexyl acrylate, for example, can be polymerized directly and need not be generated in the polymer by a transesterification with the corresponding alcohol.

In order to prepare polyacrylate PSAs having a narrow molecular weight distribution, controlled radical polymerization methods are also suitable. For the polymerization it is then preferred to use a control reagent of the general formula:

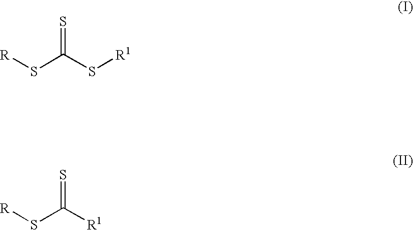

in which R and R¹, chosen independently of one another or identical, are

branched and unbranched C₁ to C₁₈ alkyl radicals; C₃ to C₁₈ alkenyl radicals; C₃ to C₁₈ alkynyl radicals;

C₁ to C₁₈ alkoxy radicals;

C₃ to C₁₈ alkynyl radicals; C₃ to C₁₈ alkenyl radicals; C₁ to C₁₈ alkyl radicals substituted by at least one OH group or a halogen atom or a silyl ether;

C₂ to C₁₈ heteroalkyl radicals having at least one oxygen atom and/or one NR* group in the carbon chain, R* representing any (especially organic) radical;

C₃ to C₁₈ alkynyl radicals, C₃ to C₁₈ alkenyl radicals, C₁ to C₁₈ alkyl radicals substituted by at least one ester group, amine group, carbonate group, cyano group, isocyanato group and/or epoxide group and/or by sulfur,

C₃ to C₁₂ cycloalkyl radicals;

C₆ to C₁₈ aryl or benzyl radicals;

hydrogen.

Control reagents of type (I) are chosen preferably from further-restricted compounds, as follows:

Halogen atoms therein are preferably F, Cl, Br or 1, more preferably Cl and Br. As alkyl, alkenyl, and alkynyl radicals in the various substituents, both linear and branched chains are outstandingly suitable.

Examples of alkyl radicals containing from 1 to 18 carbon atoms are methyl, ethyl, propyl, isopropyl, butyl, isobutyl, t-butyl, pentyl, 2-pentyl, hexyl, heptyl, octyl, 2-ethylhexyl, t-octyl, nonyl, decyl, undecyl, tridecyl, tetradecyl, hexadecyl and octadecyl.

Examples of alkenyl radicals having from 3 to 18 carbon atoms are propenyl, 2-butenyl, 3-butenyl, isobutenyl, n-2,4-pentadienyl, 3-methyl-2-butenyl, n-2-octenyl, n-2-dodecenyl, isododecenyl and oleyl.

Examples of alkynyl having from 3 to 18 carbon atoms are propynyl, 2-butynyl, 3-butynyl, n-2-octynyl and n-2-octadecynyl.

Examples of hydroxy-substituted alkyl radicals are hydroxypropyl, hydroxybutyl and hydroxyhexyl.

Examples of halogen-substituted alkyl radicals are dichlorobutyl, monobromobutyl and trichlorohexyl.

A suitable C₂-C₁₈ heteroalkyl radical having at least one oxygen atom in the carbon chain is, for example, —CH₂—CH₂—O—CH₂—CH₃.

Examples of C₃-C₁₂ cycloalkyl radicals include cyclopropyl, cyclopentyl, cyclohexyl and trimethylcyclohexyl.

Examples of C₆-C₁₈ aryl radicals include phenyl, naphthyl, benzyl, 4-tert-butylbenzyl or further substituted phenyl, such as ethylbenzene, toluene, xylene, mesitylene, isopropylbenzene, dichlorobenzene or bromotoluene.

The above listings serve only as examples of the respective groups of compounds, and make no claim to completeness.

Moreover, compounds of the following types may also be used as control reagents

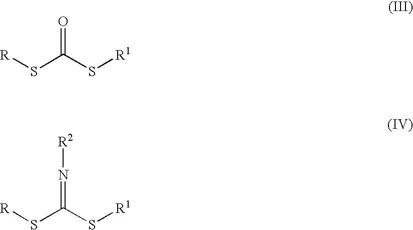

where likewise R2 may be chosen independently of R and R1 but from the above-recited group for these radicals.

In the case of the conventional “RAFT” process, polymerization is normally carried out only to low conversions (WO 98/01478 A1) in order to obtain very narrow molecular weight distributions. As a result of the low conversions, however, these polymers cannot be used as PSAs and in particular not as hotmelt PSAs, since the high fraction of residual monomers adversely affects the technical adhesive properties; the residual monomers would contaminate the solvent recyclate in the concentration process and the corresponding self-adhesive tapes would exhibit very high outgassing behavior. In order to circumvent this drawback of low conversions, in one particularly preferred procedure the polymerization is initiated a number of times.

As a further controlled radical polymerization method it is possible to carry out nitroxide-controlled polymerizations. In an advantageous procedure, radical stabilization is effected using nitroxides of type (Va) or (Vb):

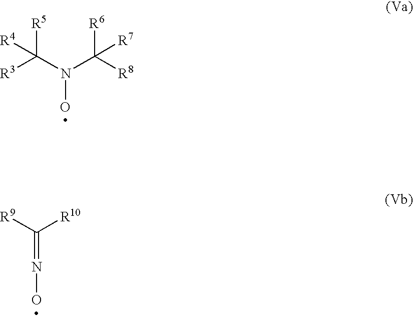

where R3, R4, R5, R6, R7, R8, R9, and R10 independently of one another denote the following compounds or atoms:

i) halides, such as chlorine, bromine or iodine,

ii) linear, branched, cyclic, and heterocyclic hydrocarbons having from 1 to 20 carbon atoms, which may be saturated, unsaturated or aromatic,

iii) esters —COOR¹¹, alkoxides —OR¹² and/or phosphonates —PO(OR¹³)₂,

where R¹¹, R¹², and R¹³ stand for radicals from group ii).

Compounds of structure (Va) or (Vb) may also be attached to polymer chains of any kind (primarily in the sense that at least one of the abovementioned radicals constitutes a polymer chain of this kind) and may therefore be used to construct the polyacrylate PSAs.

With more preference, controlled regulators which can be chosen from the following list are used for the polymerization:

2,2,5,5-tetramethyl-1-pyrrolidinyloxyl (PROXYL), 3-carbamoyl-PROXYL, 2,2-dimethyl-4,5-cyclohexyl-PROXYL, 3-oxo-PROXYL, 3-hydroxylimine-PROXYL, 3-aminomethyl-PROXYL, 3-methoxy-PROXYL, 3-t-butyl-PROXYL, 3,4-di-t-butyl-PROXYL

2,2,6,6-tetramethyl-1-piperidinyloxyl (TEMPO), 4-benzoyloxy-TEMPO, 4-methoxy-TEMPO, 4-chloro-TEMPO, 4-hydroxy-TEMPO, 4-oxo-TEMPO, 4-amino-TEMPO, 2,2,6,6-tetraethyl-1-piperidinyloxyl, 2,2,6-trimethyl-6-ethyl-1-piperidinyloxyl

N-tert-butyl 1-phenyl-2-methylpropyl nitroxide

N-tert-butyl 1-(2-naphthyl)-2-methylpropyl nitroxide

N-tert-butyl 1-diethylphosphono-2,2-dimethylpropyl nitroxide

N-tert-butyl 1-dibenzylphosphono-2,2-dimethylpropyl nitroxide

N-(1-phenyl-2-methylpropyl) 1-diethylphosphono-1-methylethyl nitroxide

di-t-butyl nitroxide

diphenyl nitroxide

t-butyl t-amyl nitroxide.

A range of further polymerization methods in accordance with which the PSAs may alternatively be prepared can be chosen from the prior art:

U.S. Pat. No. 4,581,429 A discloses a controlled-growth radical polymerization process which uses as its initiator a compound of the formula R′R″N—O—Y, in which Y denotes a free radical species which is able to polymerize unsaturated monomers. In general, however, the reactions have low conversion rates. A particular problem is the polymerization of acrylates, which takes place only with very low yields and molar masses. WO 98/13392 A1 describes open-chain alkoxyamine compounds which have a symmetrical substitution pattern. EP 735 052 A1 discloses a process for preparing thermoplastic elastomers having narrow molar mass distributions. WO 96/24620 A1 describes a polymerization process in which very specific radical compounds, such as phosphorus-containing nitroxides based on imidazolidine, are used. WO 98/44008 A1 discloses specific nitroxyls based on morpholines, piperazinones and piperazinediones. DE 199 49 352 A1 describes heterocyclic alkoxyamines as regulators in controlled-growth radical polymerizations. Corresponding further developments of the alkoxyamines or of the corresponding free nitroxides improve the efficiency for the preparation of polyacrylates (Hawker, contribution to the National Meeting of The American Chemical Society, Spring 1997; Husemann, contribution to the IUPAC World Polymer Meeting 1998, Gold Coast).

As a further controlled polymerization method, atom transfer radical polymerization (ATRP) can be used advantageously to synthesize the polyacrylate PSAs, in which case use is made preferably as initiator of monofunctional or difunctional secondary or tertiary halides and, for abstracting the halide(s), of complexes of Cu, Ni, Fe, Pd, Pt, Ru, Os, Rh, Co, Ir, Ag or Au (EP 0 824 111 A1; EP 826 698 A1; EP 824 110 A1; EP 841 346 A1; EP 850 957 A1). The various possibilities of ATRP are further described in U.S. Pat. Nos. 5,945,491 A, 5,854,364 A, and 5,789,487 A.

Orientation, Coating Processes, Application of the Pressure Sensitive Adhesive to the Backing Material

In order to produce oriented PSAs, the polymers described above are preferably coated as hotmelt systems (i.e., from the melt). For the production process it may therefore be necessary to remove the solvent from the PSA. In principle it is possible here to use any of the techniques known to the skilled worker. One very preferred technique is that of concentration using a single-screw or twin-screw extruder. The twin-screw extruder may be operated corotatingly or counterrotatingly. The solvent or water is distilled off preferably by way of several vacuum stages. Moreover, counterheating is carried out depending on the distillation temperature of the solvent. The residual solvent fractions are preferably <1%, more preferably <0.5% and very preferably <0.2%. The hotmelt is processed further from the melt.

In one preferred embodiment, orientation within the PSA is produced by the coating process. For coating as a hotmelt, and hence also for orientation, it is possible to employ a variety of coating techniques. In one embodiment the polyacrylate PSAs are coated by a roll coating process, and the orientation is produced by drawing. Various roll coating techniques are described in the “Handbook of Pressure Sensitive Adhesive Technology” by Donatas Satas (van Nostrand, New York, 1989). In another version the orientation is achieved by coating through a melt die. A distinction can be made here between the contact process and the non contact process. Orientation of the PSA here can be produced on the one hand within the coating die, by virtue of the die design, or else following emergence from the die, by a drawing process. The orientation is freely adjustable. The draw ratio can be controlled, for example, by the width of the die gap. Drawing occurs whenever the layer thickness of the PSA film on the backing material to be coated is less than the width of the die gap.

In another preferred process, the orientation is achieved by extrusion coating. Extrusion coating is preferably performed using an extrusion die. The extrusion dies used may originate with advantage from one of the three following categories: T-dies, fishtail dies, and coathanger dies. The individual types differ in the design of their flow channel. Through the form of the extrusion die it is likewise possible to produce an orientation within the hotmelt PSA. Additionally, here, in analogy to melt die coating, it is likewise possible to obtain an orientation following emergence from the die, by drawing the PSA tape film.

In order to produce oriented acrylic PSAs, it is particularly preferred to carry out coating onto a backing using a coathanger die, specifically in such a way that a polymer layer is formed on the backing by means of a movement of die relative to backing.

The time which elapses between coating and crosslinking is preferably short. In one preferred procedure, crosslinking is carried out after less than 60 minutes, in another preferred procedure, after less than 3 minutes, and in a very preferred procedure, in an inline process, after less than 5 seconds.

The backing material to which the PSA is applied may be a single-sided or double-sided adhesive tape with at least one permanent backing (or carrier).

In one preferred procedure, coating is carried out directly onto a backing material. The PSA is applied preferably to one or both sides of the backing material. Suitable backing materials include, in principle, films such as BOPP or MOPP, PET or PVC, for example, or papers or nonwovens (based on: cellulose or polymers). Also suitable, moreover, as coating substrates are foams (e.g., PUR, PE, PE/EVA, EPDM, PP, PE, silicone, etc.) or release papers (glassine paper, kraft paper, polyolefin-coated paper) or release films (PET, PP or PE, or combinations of these materials).

As an alternative, it is also possible to punch unbacked PSA tapes. In this case, the support material to which the PSA is applied comprises a temporary support, on which the material to be punched, such as an adhesive tape which is unbacked per se, is reversibly placed. Particularly suitable for this purpose are correspondingly coated support materials, such as the release papers or release films described above.

Temporary supports of this kind may also be used additionally for materials with a backing, particularly for stabilization purposes during the punching operation.

Additionally, and particularly for the purpose of separating the individual PSA webs, the material to be punched may advantageously be lined with release film or release paper.

The best orientation effects are obtained by deposition onto a cold surface. Consequently, the backing material during coating should be cooled directly by means of a roller. The roller can be cooled by a liquid film/contact film from the outside or inside, or by a coolant gas. The coolant gas may likewise be used to cool the adhesive emerging from the coating die. In one preferred procedure the roller is wetted with a contact medium, which is then located between the roller and the backing material. Preferred embodiments for the implementation of such a technique are described later on below.

For this process it is possible to use both a melt die and an extrusion die. In one very preferred procedure the roller is cooled to room temperature, in an extremely preferred procedure to temperatures below 10° C. The roller ought to rotate as well.

In a further procedure as part of this preparation process, moreover, the roller is used for crosslinking of the oriented PSA.

UV crosslinking is effected by irradiation with shortwave ultraviolet radiation in a wavelength range from 200 to 400 nm, depending on the UV photoinitiator used, especially using high or medium pressure mercury lamps with an output of from 80 to 240 W/cm. The irradiation intensity is adapted to the respective quantum yield of the UV photoinitiator, the degree of crosslinking to be brought about, and the extent of the orientation.

A further option is to crosslink the polyacrylate PSA with electron beams. Typical irradiation equipment which may be used include linear cathode systems, scanner systems, and segmented cathode systems, where electron beam accelerators are concerned. A detailed description of the state of the art, and the most important process parameters, can be found in Skelhorne, Electron Beam Processing, in Chemistry and Technology of UV and EB formulation for Coatings, Inks and Paints, Vol. 1, 1991, SITA, London. The typical acceleration voltages are situated in the range between 50 kV and 500 kV, preferably between 80 kV and 300 kV. The scatter doses employed range between 5 and 150 kGy, in particular between 20 and 100 kGy.

It is also possible to employ both crosslinking methods, or other methods which permit high-energy irradiation.

In a further preferred preparation process, the oriented PSAs are coated onto a roller provided with a contact medium. As a result of the contact medium it is possible in turn to carry out very rapid cooling of the PSA. Advantageously, lamination is then carried out onto the backing material later.

Furthermore, as the contact medium it is also possible to use a material which has the capacity to bring about contact between the PSA and the surface of the roller, especially a material which fills the cavities between backing material and roller surface (for example, unevennesses in the roller surface, bubbles). In order to implement this technology, a rotating cooling roller is coated with a contact medium. In one preferred procedure the contact medium chosen is a liquid, such as water, for example.

Examples of appropriate additives to water as the contact medium include alkyl alcohols such as ethanol, propanol, butanol, and hexanol, without wishing to be restricted in the selection of the alcohols as a result of these examples. Also especially advantageous are longer-chain alcohols, polyglycols, ketones, amines, carboxylates, sulfonates, and the like. Many of these compounds lower the surface tension or raise the conductivity.

A lowering in the surface tension may also be achieved by adding small amounts of nonionic and/or anionic and/or cationic surfactants to the contact medium. The most simple way of achieving this is by using commercial washing compositions or soap solutions, preferably in a concentration of a few g/l in water as the contact medium. Particularly suitable compounds are special surfactants which can be used even at low concentrations. Examples thereof include sulfonium surfactants (e.g., β-di(hydroxyalkyl)sulfonium salt), and also, for example, ethoxylated nonylphenylsulfonic acid ammonium salts or block copolymers, especially diblocks. Here, reference may be made in particular to the state of the art under “surfactants” in Ullmann's Encyclopedia of Industrial Chemistry, Sixth Edition, 2000 Electronic Release, Wiley-VCH, Weinheim 2000.

As contact media it is possible to use the abovementioned liquids, even without the addition of water, in each case alone or in combination with one another.

In order to improve the properties of the contact medium (for example, for increasing the shearing resistance, reducing the transfer of surfactants or the like to the surface of the liner, and thus improve cleaning possibilities of the end product), salts, gels, and similar viscosity-increasing additives may also be added with advantage to the contact medium and/or to the adjuvants used.

Moreover, the roller can be macroscopically smooth or may have a surface with a low level of structuring. It has been found appropriate for the roller to possess a surface structure, especially a surface roughening. This allows wetting by the contact medium to be improved.

The coating process proceeds to particularly good effect if the roller is temperature-controllable, preferably with a range from −30° C. to 200° C., with very particular preference from 5° C. to 25° C.

The contact medium is preferably applied to the roller. A second roller, which takes up the contact medium, may be used for continuous wetting of the coating roller. It is, however, also possible to carry out contactless application, by spraying, for example.

For the variant of the preparation process in which the roller is used simultaneously for use, for example, with electron beams, it is common to use a grounded metal roller which absorbs the incident electrons and the X-radiation that has formed.

In order to prevent corrosion, the roller is commonly coated with a protective coat. This coat is preferably selected so that it is wetted effectively by the contact medium. In general, the surface is conductive. It may also be more favorable, however, to coat it with one or more coats of insulating or semiconducting material.

Where a liquid is used as the contact medium, one outstanding procedure is to run a second roller, advantageously having a wettable or absorbent surface, through a bath containing the contact medium, said roller then becoming wetted by or impregnated with the contact medium and applying a film of said contact medium by contact with the roller.

In one preferred procedure, the PSA is coated directly on the contact medium roller, and crosslinked. For this purpose it is possible in turn to use the methods and equipment described for UV crosslinking and EB crosslinking. Then, following crosslinking, the oriented PSA is transferred onto a backing material. The backing materials already cited can be used.

The characterization of the orientation within the acrylic PSAs is dependent on the coating process. The orientation can be controlled, for example, by the die temperature and coating temperature and also by the molecular weight of the polyacrylate PSA.

The degree of orientation is freely adjustable through the die gap width. The thicker the PSA film expressed from the coating die, the greater the extent to which the adhesive can be drawn to a relatively thin PSA film on the backing material. This drawing operation may be freely adjusted not only by the freely adjustable die width but also by the web speed of the decreasing backing material.

The orientation of the adhesive can be measured with a polarimeter, by infrared dichroism, or using X-ray scattering. It is known that in many cases the orientation in acrylic PSAs in the uncrosslinked state is retained only for a few days. During rest or storage, the system relaxes and loses its preferential direction. As a result of crosslinking after coating, this effect can be strengthened significantly. The relaxation of the oriented polymer chains converges toward zero, and the oriented PSAs can be stored for a very long period of time without loss of their preferential direction.

In addition to measuring the orientation by determining the Δn (test C), the measurement of the shrinkback in the free film (see test B) is likewise suitable for determining the orientation and the anisotropic properties of the PSA.

In addition to the processes described, the orientation may also be produced following coating. In that case, then, an extensible backing material is preferably employed, with the PSA being drawn at the same time as stretching. In this case it is also possible to use acrylic PSAs coated conventionally from solution or from water. In one preferred procedure, then, this drawn PSA is in turn crosslinked with actinic radiation.

Punching Processes

In the inventive process the punching process takes place continuously. For punching processes of this kind it is possible with outstanding effect to make use, for example, of rotary punches. The punching process may be a punch-through process or a kiss-cut process. Accordingly, the following variants may be implemented advantageously:

the punching process severs the adhesive on the backing material completely,

the punching process severs the adhesive on the backing material incompletely,

the punching process severs the adhesive-coated backing material completely,

the punching process does not sever or only partly severs the adhesive-coated backing material.

Advantageously, the backing material with the PSA applied to it can be introduced into the punching process in such a way that the working direction (machine direction, MD) corresponds to the preferential direction VR of the PSA or, alternatively, perpendicularly thereto. Very advantageously, the PSA guided through the punching process and the punching tools are aligned with respect to one another in such a way that the punched incisions extend preferably perpendicular to the preferential direction of the PSA.

Application of the PSA to the backing material, and the subsequent punching process, can be implemented in an inline process, i.e., in a combined unit and/or in a continuous sequence.

Alternatively, it may be very advantageous to separate the coating process from the punching process in terms of time and/or space.

These punching operations may advantageously be built into operations, so that the inventive process advantageously comprises two or more, or all, of the following steps. Described by way of example is the processing of a double-sided PSA tape.

Variant A, Continuous Operation:

1. Unwinding of the double-sided test adhesive tape and of the siliconized auxiliary release material.

2. Laminating a siliconized auxiliary release material upstream of the rotary punching cylinder from above onto the open, sticky side of the test adhesive tape.

3. Rotary punching: severing of the siliconized auxiliary release material and of the adhesive bond. Ideally, penetration of the punching tools into the siliconized surface of the original release material of the double-sided test adhesive tape is minimal.

4. Matrix stripping: stripping of the lattice. The punched products remain on the original release material.

5. Rolling up of the finished products (i.e., punched products on original release material backing, lined with auxiliary release material) and of the stripped matrix.

Variant B, Continuous Operation:

1. Unwinding of the double-sided test adhesive tape and of the siliconized auxiliary release material.

2. Laminating of the test adhesive tape with the sticky side downward onto a siliconized auxiliary release material upstream of the rotary punching cylinder.

3. Rotary punching: severing of the double-sided siliconized auxiliary release material and of the adhesive bond. Ideally, penetration of the punching tools into the siliconized surface of the auxiliary release material is minimal.

4. Matrix stripping: stripping of the lattice. The punched products remain on the siliconized auxiliary release material.

5. Rolling up of the finished products (i.e., punched products on auxiliary release material backing, lined with original release material) with the punched products, and of the stripped matrix.

Examples of the speed at which the adhesive-coated backing material runs through the unit are from 0.1 m/min to 100 m/min. Common current real-life speeds for punching processes are from 10 to 30 m/min.

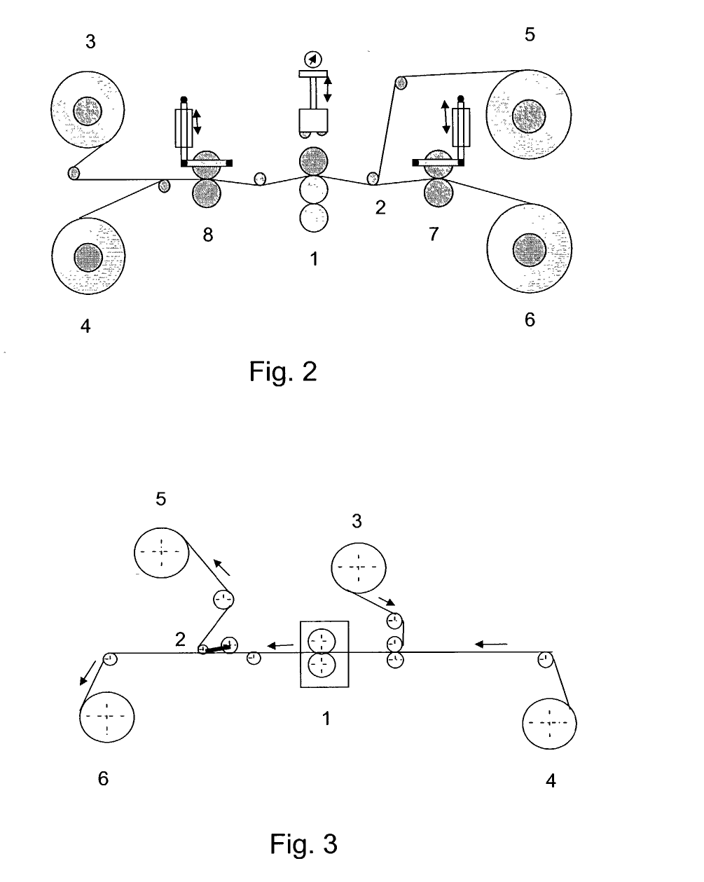

FIG. 2 and FIG. 3 illustrate, by way of example, two cross sections through punching units of this kind, FIG. 2 including an integrated laminating station. In these figures, the reference numerals have the following meanings:

1 rotary punching unit

2 matrix stripper

3 unwinder for the siliconized release material

4 unwinder for the material to be punched, especially the adhesive tape

5 winder for the matrix

6 winder for the finished product

7 tension station

8 laminating station

Use

The invention additionally provides punched products which can be or have been obtained by the inventive process in one of its embodiments.

Punched products of this kind can be used as single-sided or double-sided adhesive products, for adhesive bonding in the home and in industry, especially in automotive construction, in the electrical and electronics industry, for all assembly purposes, such as for assembly of signs, badges, and film keyboards, for example, in the medical sector (patches, wound coverings) and the like, to mention but a few exemplary applications. Generally speaking, the punched products can be used wherever punched single-sided adhesive labels and double-sided adhesive films are presently in use.

Experiments

The invention is described below by means of experiments, without wishing to impose any unnecessary restriction by the choice of samples investigated.

The following test methods have been employed.

Gel Permeation Chromatography GPC (Test A)

The average molecular weight Mw and the polydispersity PD were determined by gel permeation chromatography. The eluent used was THF containing 0.1% by volume trifluoroacetic acid. Measurement was made at 25° C. The precolumn used was PSS-SDV, 5 μ, 10³ Å, ID 8.0 mm×50 mm. Separation was carried out using the columns PSS-SDV, 5 μ, 10³ and also 105 and 106 each with ID 8.0 mm×300 mm. The sample concentration was 4 g/l, the flow rate 1.0 ml per minute. Measurement was made against PMMA standards.

Measurement of the Shrinkback (Test B)

Strips with a width of at least 30 mm and a length of 20 cm were cut parallel to the coating direction of the hotmelt. At application rates of 100 g/m², 4 strips were laminated to one another, at 50 g/m² 8 strips were laminated to one another, in order to give comparable layer thicknesses. The specimen obtained in this way was then cut to a width of exactly 20 mm and was overstuck at each end with paper strips, with a spacing of 15 cm. The test specimen thus prepared was then suspended vertically at RT and the change in length was monitored over time until no further shrinkage of the sample could be found. The initial length reduced by the final value was then reported, relative to the initial length, as the shrinkback, in percent.

For measuring the orientation after a longer time, the coated and oriented pressure sensitive adhesives were stored in the form of swatches for a prolonged period, and then analyzed.

Measurement of the Birefringence (Test C)

Version 1

Two crossed polarization filters were placed in the sample beam of a Uvikon 910 spectrophotometer. Oriented acrylates were fixed between two slides. The path length of the oriented sample was determined from preliminary experiments by means of thickness gauges. The sample thus prepared was placed in the measuring beam of the spectrophotometer with its direction of orientation deviating in each case by 45° from the optical axes of the two polarization filters. The transmission was then monitored over time by means of a time-resolved measurement.

The transmission data were then used to determine the birefringence in accordance with the following relationship:

T=sin²(π×R)

$$The retardation R is made up as follows : R = \frac{d}{λ} Δ n$$

$$The transmission is also given from : T = \frac{{I}_{t}}{{I}_{0}}$$

$$This ultimately provides , for the birefringence : Δ n = \frac{λ}{π d} arcsin \sqrt{T} .$$

In the formulae,

d=sample thickness

λ=wavelength

Iₜ=intensity of the emergent (transmitted) light beam

I₀=intensity of the incident light beam

Version 2

The birefringence was measured with an experimental setup such as described analogously in the Encyclopedia of Polymer Science, John Wiley & Sons, Vol. 10, p. 505, 1987 as a circular polariscope. The light emitted by a diode-pumped solid-state laser of wavelength λ=532 nm is first of all linearly polarized by a polarization filter and then circularly polarized using a λ/4 plate with λ=532 nm. The laser beam thus polarized is then passed through the oriented acrylate composition. Since acrylate compositions are highly transparent, the laser beam is able to pass through the composition virtually unhindered. Where the polymer molecules of the acrylate composition are oriented, this results in a change in the polarizability of the acrylate composition depending on observation angle (birefringence). As a result of this effect, the electrical field vector of the circularly polarized laser beam undergoes a rotation about the axis of progression of the laser beam. After departing the sample, the laser beam thus manipulated is passed through a second λ/4 plate with λ=532 nm whose optical axis deviates by 90° from the optical axis of the first λ/4 plate. This filter is followed by a second polarization filter which likewise deviates by 90° from the first polaroid filter. Finally, the intensity of the laser beam is measured using a photosensor.

Preparation of the Samples

Polymer 1

A 200 L reactor conventional for radical polymerizations was charged with 2 400 g of acrylic acid, 64 kg of 2-ethylhexyl acrylate, 6.4 kg of N-isopropylacrylamide and 53.3 kg of acetone/isopropanol (95:5). After nitrogen gas had been passed through for 45 minutes with stirring, the reactor was heated to 58° C. and 40 g of 2,2′-azoisobutyronitrile (AIBN) were added. The external heating bath was then heated to 75° C. and the reaction was carried out constantly at this external temperature. After a reaction time of 1 hour a further 40 g of AIBN were added. After 5 hours and 10 hours, dilution was carried out in each case with 15 kg of acetone/isopropanol (95:5). After both 6 hours and 8 hours, 100 g of dicyclohexyl peroxydicarbonate (Perkadox 16®, Akzo Nobel) in solution each in 800 g of acetone were added. The reaction was terminated after a time of 24 hours, and the product was cooled to room temperature. Determination of the molecular weight by test A gave an Mw=814 000 g/mol with a polydispersity Mw/Mn=5.2.

Polymer 2

A 200 L reactor conventional for radical polymerizations was charged with 1 200 g of acrylic acid, 74 kg of 2-ethylhexyl acrylate, 4.8 kg of N-isopropylacrylamide and 53.3 kg of acetone/isopropanol (95:5). After nitrogen gas had been passed through for 45 minutes with stirring, the reactor was heated to 58° C. and 40 g of 2,2′-azoisobutyronitrile (AIBN) were added. The external heating bath was then heated to 75° C. and the reaction was carried out constantly at this external temperature. After a reaction time of 1 hour a further 40 g of AIBN were added. After 5 hours and 10 hours, dilution was carried out in each case with 15 kg of acetone/isopropanol (95:5). After both 6 hours and 8 hours, 100 g of dicyclohexyl peroxydicarbonate (Perkadox 16®, Akzo Nobel) in solution each in 800 g of acetone were added. The reaction was terminated after a time of 24 hours, and the product was cooled to room temperature. Determination of the molecular weight by test A gave an Mw=801 000 g/mol with a polydispersity Mw/Mn=5.7.

i) Sample Preparation for Determining the Shrinkback

The pressure sensitive adhesives in solution were concentrated on a Bersdorff concentrating extruder with a throughput of approximately 40 kg/h at a temperature of approximately 115° C. Following concentration the residual solvent fraction was less than 0.5% by weight. The composition was then coated onto a 12 μm PET film coated beforehand with 1.5 g/m² silicone (polydimethylsiloxane), application of the composition taking place through a coathanger extrusion die with a die gap of 300 μm and a coating width of 33 cm, at a defined coating temperature (composition temperature) and a web speed of 10 m/min. The draw ratio was set at 3:1 for an application rate of 100 μm2 (PSA film approximately 100 μm thick) and at 6:1 at an application rate of 50 g/m2 (PSA film approximately 50 μm thick).

The siliconized PET film is passed over a corotating steel roller which is cooled to 5° C. At the point of contact between the PSA film and the PET film, therefore, the PSA film is immediately cooled. The application rate was 50 or 100 g/m². In the inline process, after a section of about 5 m, the PSA tape is then crosslinked either with UV radiation or electron beams.

For electron beam irradiation, crosslinking was carried out with an instrument from Electron Crosslinking AB, Halmstad, Sweden. The coated PSA tape was passed through under the Lenard window of the accelerator over a cooling roller which is present as standard. In the irradiation zone, the atmospheric oxygen is displaced by flushing with pure nitrogen. The web speed was in each case 10 m/min. Irradiation was carried out with an accelerating voltage of 200 kV.

For UV irradiation, a medium pressure mercury vapor lamp from Eltosch with an intensity of 160 W/cm² was used. The UV dose was approximately 1.6 J/cm². Irradiation was carried out under an air atmosphere.

In order to determine the shrinkback and therefore the extent of orientation, test B was carried out.

ii) Preparation of the Oriented PSA Tapes for the Punching Process

A procedure analogous to that under i) was followed. However, the backing material used was a 12 μm thick PET film which had been freshly corona pretreated. All process parameters (web speed, coating temperature, draw ratio, polyacrylate PSA, crosslinking dose) were kept constant. To produce the punched products, the PSA was first coated onto the corona-treated PET film, and crosslinked, and then the adhesive side was lined with a release paper (120 μm polyolefinically (PE) coated paper, siliconized on both sides, 1.4 g/m² polydimethylsiloxane, from Loparex or 100 μm glassine release paper, siliconized on one side, cf. table 2). In the second step, the PSA already crosslinked from i) was laminated onto the other side of the PET film, the PSA being pressed on by a roller and then the siliconized PET film being delaminated. Finally, the double-sided PSA tape was rolled up.

The second work step was dropped for the production of just single-sided adhesive specimens.

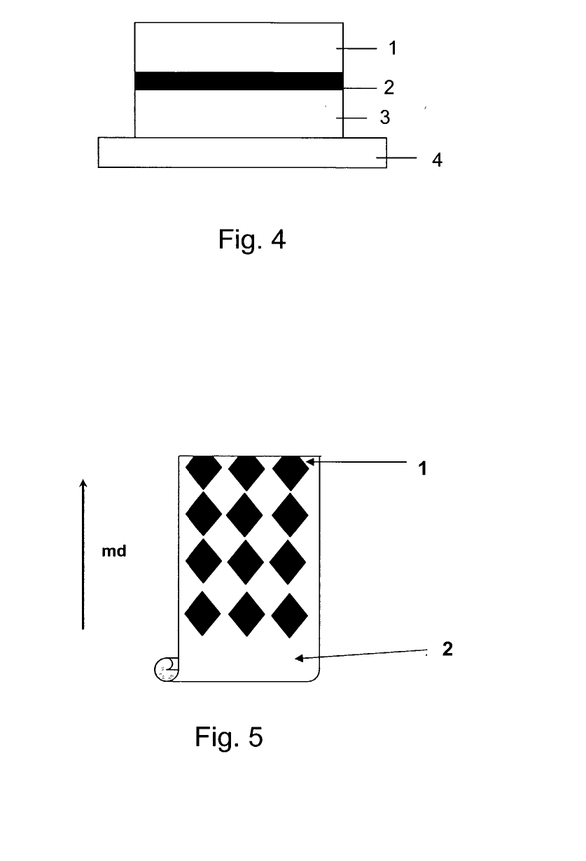

FIG. 4 shows a sketch of the structure of the corresponding specimens.

In FIG. 4, the reference numerals have the following meanings:

1 anisotropic pressure sensitive adhesive

2 PET film backing, in this case 12 μm

3 anisotropic pressure sensitive adhesive

4 release material

iii) Preparation of the Unoriented PSA Tapes for the Punching Process

The pressure sensitive adhesives in solution were coated onto a siliconized release paper (120 μm polyolefinically (PE) coated paper, siliconized on both sides, 1.4 g/m² polydimethylsiloxane, from Loparex or 100 μm glassine release paper, siliconized on one side, cf. table 2) (application method: coating bar). In a drying tunnel the solvent was removed through a plurality of temperature zones, heating being carried out at 50° C. in the first zone, then at 80° C., and at 100° C. in the last three heating zones. The web speed was 10 m/min. Following removal of the solvents thermally, the 12 μm thick PET film was laminated on. In a second step, dissolved PSA was coated in turn onto the PET film of this assembly. The solvent was removed thermally. Finally, the double-sided PSA tape was rolled up.

The second work step was dropped for the production of just single-sided adhesive specimens.

PSA Tape A

Polymer 1 is concentrated as in i) and, as in ii), is coated at 2×100 g/m² onto a 12 μm thick PET film. The coating temperature was 150° C. Crosslinking was carried out with an EB dose of 30 kGy.

PSA Tape B

Polymer 1 is concentrated as in i) and, as in ii), is coated at 2×50 g/m² onto a 12 μm thick PET film. The coating temperature was 150° C. Crosslinking was carried out with an EB dose of 30 kGy.

PSA Tape C

Polymer 1 is concentrated as in i) and, as in ii), is coated at 100 g/m² onto a 12 μm thick PET film. The coating temperature was 150° C. Crosslinking was carried out with an EB dose of 30 kGy.

PSA Tape D

Polymer 1 in solution is blended with 0.5% by weight of isopropylthioxanthone (Speedcure ITX, from Rahn), based on the polymer. Subsequently, the blend is concentrated as in i) and, as in ii), is coated at 2×100 g/m² onto a 12 μm thick PET film. The coating temperature was 150° C. Crosslinking was carried out with a UV dose of 2.5 J/cm².

PSA Tape E

Polymer 1 in solution is blended with 0.5% by weight of isopropylthioxanthone (Speedcure ITX, from Rahn), based on the polymer. Subsequently, the blend is concentrated as in i) and, as in ii), is coated at 2×50 g/m² onto a 12 μm thick PET film. The coating temperature was 150° C. Crosslinking was carried out with a UV dose of 2.0 J/cm².

PSA Tape F

Polymer 1 in solution is blended with 2% by weight of Genomer 4212® (polyurethane diacrylate from Rahn) and with 30% by weight of DT 110 (terpene-phenolic resin from DRT). Subsequently, the blend is concentrated as in i) and, as in ii), is coated at 2×100 g/m² onto a 12 μm thick PET film. The coating temperature was 150° C. Crosslinking was carried out with an EB dose of 70 kGy.

PSA Tape G

Polymer 1 in solution is blended with 2% by weight of Genomer 4212® (polyurethane diacrylate from Rahn) and with 30% by weight of DT 110 (terpene-phenolic resin from DRT). Subsequently, the blend is concentrated as in i) and, as in ii), is coated at 2×50 g/m² onto a 12 μm thick PET film. The coating temperature was 150° C. Crosslinking was carried out with an EB dose of 70 kGy.

PSA Tape H

Polymer 1 in solution is blended with 2% by weight of Genomer 4212® (polyurethane diacrylate from Rahn) and with 30% by weight of DT 110 (terpene-phenolic resin from DRT). Subsequently, the blend is concentrated as in i) and, as in ii), is coated at 2×100 g/m² onto a 12 μm thick PET film. The coating temperature was 150° C. Crosslinking was carried out with an EB dose of 70 kGy.

PSA Tape I

Polymer 1 in solution is blended with 0.5% by weight of isopropylthioxanthone (Speedcure ITX, from Rahn), 2.5% by weight of Genomer 4212® (polyurethane diacrylate from Rahn) and with 30% by weight of DT 110 (terpene-phenolic resin from DRT). Subsequently, the blend is concentrated as in i) and, as in ii), is coated at 2×50 g/m² onto a 12 μm thick PET film. The coating temperature was 150° C. Crosslinking was carried out with a UV dose of 3.0 J/cm².

PSA Tape J

Polymer 2 in solution is blended with 2% by weight of Genomer 4212® (polyurethane diacrylate from Rahn), with 30% by weight of Novares TK 90® (C5-C9 hydrocarbon resin from VFT Rüttgers) and 8% by weight of Reofos 65® (oligophosphate from Great Lakes Chemical). Subsequently, the blend is concentrated as in i) and, as in ii), is coated at 2×100 g/m² onto a 12 μm thick PET film. The coating temperature was 120° C. Crosslinking was carried out with an EB dose of 60 kGy.

PSA Tape K

Polymer 2 in solution is blended with 2% by weight of Genomer 4212® (polyurethane diacrylate from Rahn), with 30% by weight of Novares TK 90® (C5-C9 hydrocarbon resin from VFT Rüttgers) and 8% by weight of Reofos 65® (oligophosphate from Great Lakes Chemical). Subsequently, the blend is concentrated as in i) and, as in ii), is coated at 2×50 g/m² onto a 12 μm thick PET film. The coating temperature was 120° C. Crosslinking was carried out with an EB dose of 60 kGy.

PSA Tape L

Polymer 2 in solution is blended with 2% by weight of Genomer 4212® (polyurethane diacrylate from Rahn), with 30% by weight of Novares TK 90® (C5-C9 hydrocarbon resin from VFT Rüttgers) and 8% by weight of Reofos 65® (oligophosphate from Great Lakes Chemical). Subsequently, the blend is concentrated as in i) and, as in ii), is coated at 2×100 g/m² onto a 12 μm thick PET film. The coating temperature was 120° C. Crosslinking was carried out with an EB dose of 60 kGy.

PSA Tape M

Polymer 1, as in iii), is coated from solution at 2×100 g/m² onto a 12 μm thick PET film. The drying temperature was not more than 1 00° C. Crosslinking was carried out with an EB dose of 30 kGy.

PSA Tape N

Polymer 1, as in iii), is coated from solution at 2×50 g/m² onto a 12 μm thick PET film. The drying temperature was not more than 100° C. Crosslinking was carried out with an EB dose of 30 kGy.

PSA Tape O

Polymer 1, as in iii), is coated from solution at 2×100 g/m² onto a 12 μm thick PET film. The drying temperature was not more than 100° C. Crosslinking was carried out with an EB dose of 30 kGy.

PSA Tape P

Polymer 1 in solution is blended with 2% by weight of Genomer 4212® (polyurethane diacrylate from Rahn) and with 30% by weight of DT 110 (terpene-phenolic resin from DRT). Subsequently, the blend, as in iii), is coated from solution at 2×100 g/m² onto a 12 μm thick PET film. The drying temperature was not more than 100° C. Crosslinking was carried out with an EB dose of 70 kGy.

PSA Tape R

Polymer 1 in solution is blended with 2% by weight of Genomer 4212® (polyurethane diacrylate from Rahn) and with 30% by weight of DT 110 (terpene-phenolic resin from DRT). Subsequently, the blend, as in iii), is coated from solution at 2×50 g/m² onto a 12 μm thick PET film. The drying temperature was not more than 100° C. Crosslinking was carried out with an EB dose of 70 kGy.

PSA Tape S

Polymer 1 in solution is blended with 2% by weight of Genomer 4212® (polyurethane diacrylate from Rahn) and with 30% by weight of DT 110 (terpene-phenolic resin from DRT). Subsequently, the blend, as in iii), is coated from solution at 2×100 g/m² onto a 12 μm thick PET film. The drying temperature was not more than 100° C. Crosslinking was carried out with an EB dose of 70 kGy.

PSA Tape T

Polymer 2 in solution is blended with 2% by weight of Genomer 4212® (polyurethane diacrylate from Rahn), 30% by weight of Novares TK 90® (C5-C9 hydrocarbon resin from VFT Rüttgers) and 8% by weight of Reofos 65® (oligophosphate from Great Lakes Chemical). Subsequently, the blend, as in iii), is coated at 2×100 g/m² onto a 12 μm thick PET film. The drying temperature was not more than 100° C. Crosslinking was carried out with an EB dose of 60 kGy.

PSA Tape U

Polymer 2 in solution is blended with 2% by weight of Genomer 4212® (polyurethane diacrylate from Rahn), 30% by weight of Novares TK 90® (C5-C9 hydrocarbon resin from VFT Rüttgers) and 8% by weight of Reofos 65® (oligophosphate from Great Lakes Chemical). Subsequently, the blend, as in iii), is coated at 2×50 g/m² onto a 12 μm thick PET film. The drying temperature was not more than 100° C. Crosslinking was carried out with an EB dose of 60 kGy.

PSA Tape V

Polymer 2 in solution is blended with 2% by weight of Genomer 4212® (polyurethane diacrylate from Rahn), 30% by weight of Novares TK 90® (C5-C9 hydrocarbon resin from VFT Rüttgers) and 8% by weight of Reofos 65® (oligophosphate from Great Lakes Chemical). Subsequently, the blend, as in iii), is coated at 2×100 g/m² onto a 12 μm thick PET film. The drying temperature was not more than 100° C. Crosslinking was carried out with an EB dose of 60 kGy.

Additionally as a reference example for investigating the punching process, a “SCOTCH® 9690 Laminating Adhesive” adhesive tape (3M, Neuss, Germany) was used.

Results

In a first step, 2 polymers with an average molecular weight Mw of approximately 800 000 g/mol were prepared. Using these PSAs, PSA tapes A to V were produced. Single-sided and double-sided PSA tapes were investigated, the backing or carrier material used being a 12 μm thick PET film. In order to assess the effect of punchability in different processes, a large number of different PSAs were prepared.

The PSA present on PSA tapes A,B,C,D,E and M,N,O was a straight polyacrylate without additive. A and B are different only in application rate. PSA tapes D and E are identical with A and B and differ only in the addition of UV photoinitiator and in the UV crosslinking mechanism.

PSA tapes F,G,H,I and P,R,S comprise a polyacrylate/resin blend. Additionally, a difunctional acrylate is admixed as crosslinker. Because of the addition of resin, the bond strength of the PSA tapes is significantly greater. PSA tapes F and G again differ in application rate, I again in the UV crosslinking mechanism.

PSA tapes J,K,L and T,U,V are highly tacky PSA tapes of high bond strength. Conventional PSA tapes, such as T,U,V, with soft and tacky adhesives of this kind are generally difficult, if not impossible, to punch. Therefore, PSA tapes J,K,L were likewise provided with a very soft, tacky, and oriented PSA, with the polymer being based on polyacrylate 2.

In a first investigation, the degree of orientation of the individual adhesives was determined. For the punching process, the recession behavior of the oriented PSAs is essential, since this prevents the punched products from running together. Accordingly, below, the shrinkback in the free film was determined for PSA tapes A to V by method i) in combination with test B. The results of these measurements are compiled in table 1.

Table 2 gives an overview of the properties of the materials used by way of example for the punching process.

The examples below given an overview of the punched products produced, the punching conditions selected, and the results obtained, which were observed during or after the punching process as a function of the adhesive tape used.

Table 3 gives an overview of the criteria for evaluating the punching experiments.

Overview of the Punching Processes Used:

Rotary Punch with Continuous Matrix Stripping.

The rotary punch used was from SMO, Germany. FIG. 2 shows the construction of the rotary punch. For the different punch shapes, punching cylinders from RotoMetrics International Ltd were used in each case.

The roll width of the adhesive materials used was 130 mm. The release materials laminated to them had a roll width of 145 mm.

The punching experiments with double-sided adhesive tapes were carried out by partial punching (kiss cutting) on the original release material. Upstream of the rotary punching cylinder, a second, auxiliary siliconized release material was laminated from the top onto the open, sticky side of the test adhesive tape. The auxiliary release material used was a glassine release paper siliconized on one side.

The matrix was stripped at an angle of about 800. The punching speed was 18 m/min.

The punching experiments with single-sided adhesive tapes were conducted by partial punching (kiss cutting) on a siliconized auxiliary release material. Prior to the punching process, the test adhesive tape was laminated on. The auxiliary release material used was a glassine release paper siliconized on one side (thickness: 100 μm, from Laufenberg, Krefeld, Germany).

The matix was stripped at an angle of about 80°. The punching speed was 18 m/min.

### EXAMPLES

### Example 1

Target Product

Square punched products without connecting webs, lined with siliconized release material 1 (auxiliary release material) on a siliconized support release material 2 (original release material). The diameter of the punched products is 14 mm from tip to tip. FIG. 5 is a diagram of punched products of this kind on the support material (md=MD=machine direction). Reference 1 here refers to the punched products, reference 2 to the support material.

Results

By means of anisotropically oriented PSAs, distinct process advantages can be achieved in all punching processes. As reference products, the corresponding solvent-based products were likewise punched. Since the hotmelt products and the solvent-based products are identical in terms of formulation, any effect of the formulation as a cause of the considerable improvement in punchability can be unambiguously ruled out.

The solvent-based adhesive tapes T,U,V are of only limited punchability owing to the soft PSA. The corresponding oriented hotmelt specimens J,K,L exhibit outstanding punchability in comparison.

Table 4 gives an overview of the overall punching results.

As a comparison product, additionally, an adhesive tape from 3M was punched. The double-sided adhesive tape “Scotch (TM) 9690 Laminating Adhesive” gave comparably poor punching results. The error rate range was comparable with that of the solvent-based adhesive tapes in table 4.

### Example 2

Target Product

Square punched products without connecting webs, lined with siliconized release material 1 (auxiliary release material) on a siliconized support release material 2 (original release material). The side edge length of one punched product is 5 mm.

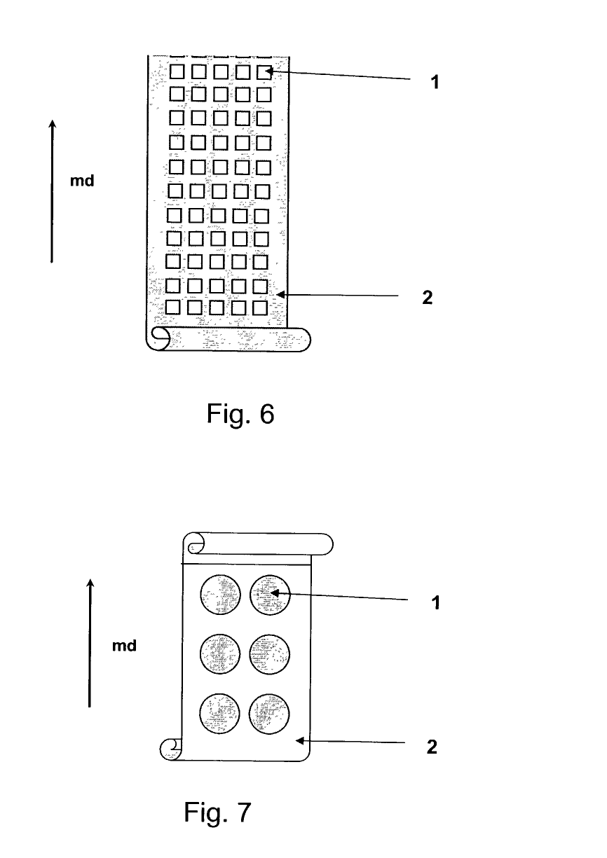

FIG. 6 is a diagram of punched products of this kind on the support material (md=MD=machine direction). Reference 1 here refers to the punched products, reference 2 to the support material.

Results

Table 5 gives an overview of the punching results. The oriented adhesive tapes have only a small number of defects, in the majority of experiments zero, in comparison in to the solvent specimens.

The matrix lattice has to be removed manually in the machine direction. Manual lattice stripping at right angles to the machine direction led to similarly poor error rates as in the case of the solvent specimens.

### Example 3

Target Product

Circular punched products of double-sidedly adhering material, lined with siliconized release material 1 (auxiliary release material) on a siliconized support release material 2 (original release material). The diameter of the punched products is 18 mm.

FIG. 7 is a diagram of punched products of this kind on the support material (md=MD=machine direction). Reference 1 here refers to the punched products, reference 2 to the support material.

Results

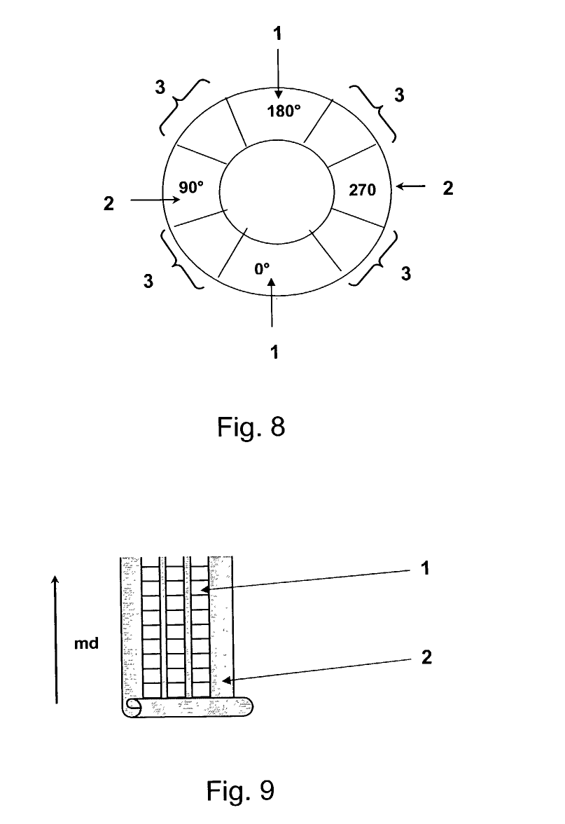

The circular punched products are characterized by a particular degree of difficulty. The shrinkback effect caused by the molecular stretching acts only at the top and bottom margins of the circle. FIG. 8 shows in detail the effect of the anisotropy on the circular punched product. VR indicates the direction of stretching. Positions 1 of the punched product show areas without “cold flow”, i.e., areas in which the shrinkback takes effect. Positions 2 show regions in which the pressure sensitive adhesive has flowed back (severe “fixing”). Reference numeral 3 refers to transitional regions.

Removal of the lattice matrix operates without problems, since these separated areas act as “grip tabs” in the matrix stripping process. Additionally, manual removal of the matrix lattice after a storage period of 2 weeks presented no problems in the direction of orientation.

Table 6 gives an overview of the punching results.

### Example 4

Target Products

Square punched products with a direct connecting edge of double-sidedly adhering material lined with siliconized release material 1 (auxiliary release material) on a siliconized support release material 2 (original release material). The side edge length of one punched product is 20 mm. FIG. 9 is a diagram of such punched products on the support material (md=MD=machine direction). Reference numeral 1 refers here to the punched products, reference numeral 2 to the support material.

The finished punched products were subsequently investigated for dispensability in an automatic dispenser device. The dispenser device used was the tesa labeling apparatus “System 5/2”.

Results

Table 7 gives an overview of the results obtained. Anisotropically oriented single-sided or double-sided adhesive tapes exhibited marked advantages in dispensing. In the dispensing tests, one self-adhesive punched portion at a time is to be transferred to a folded paper carton. For this purpose the shaped punched parts together with the support material were drawn over a sharp 90° edge. None of the punched parts with anisotropic oriented pressure sensitive adhesive showed any flow effects in the region of the common contact edge. The punched parts were detachable without problems at the dispensing edge, could be individualized, and did not pull any subsequent punched parts with them.

The adhesive tapes based on the solvent technology show strong flow effects at the common contact edge. The softer the test PSA, the greater the problems which occurred in the dispensing process.

Another trialed product from 3M (“Scotch (TM) 9690 Laminating Adhesive”) also did not provide error-free dispensing. In some cases, up to four punched products were transferred in one detachment operation.

### Example 5

In further punching experiments, contamination of the punching tools was investigated as a function of the adhesive tape used. The experiments were each conducted with 20 000 linear meters of test material. Afterward, a qualitative assessment of the punching tools was made. Table 8 gives an overview of the results.

Results

Anisotropically oriented pressure sensitive adhesives show much less of a tendency to contaminate the punching tools than do their unoriented counterparts. As a result of the reduced flow in the machine direction by the anisotropically oriented PSAs, the contact time between punching tool and adhesive is reduced. Contamination of the punching tools is less, and they have a much longer service life. This favorable effect is reinforced by the resilience of the anisotropically oriented PSAs. Residues of adhesives adhering to the punching tools are detached from the tool during the punching operation as a result of the shrinkback.

For comparison, a 3M product was punched as well. The double-sided “Scotch (TM) 9690 Laminating Adhesive” tape had a contamination tendency that was comparable with that of the solvent-based specimens investigated.

FIG. 1 shows a microscopic enlargement of one edge of a punched product after the punching process. The recession of the adhesive as a result of the anisotropic orientation can be seen. The shrinkback in the free film according to test method B was 91% in this case.

TABLE 1
Overview of shrinkback values obtained in the free film (Test B).

| | Shrinkback in the free film |
|---|---|
| PSA for PSA tapes | Test B |
| A | 66% |
| B | 72% |
| C | 66% |
| D | 56% |
| E | 62% |
| F | 63% |
| G | 68% |
| H | 63% |
| I | 50% |
| J | 59% |
| K | 66% |
| L | 59% |
| M | 0% |
| N | 0% |
| O | 0% |
| P | 0% |
| R | 0% |
| S | 0% |
| T | 0% |
| U | 0% |
| V | 0% |

TABLE 2
Overview of the single-sided and double-sided adhesive tapes used in the punching experiments. The table shows the product
structure and the production process and the type of crosslinking used to produce the tape. The backing film used was a
12 μm thick PET film from SKC, Korea.

| | PSA | | Product structure | | | |
|---|---|---|---|---|---|---|
| Adhesive | crosslinking | Tape production | Application rate | Application rate | | |
| tape | method used | process | open side | lined side | Backing film | Release material |
| A | ESH | Hotmelt coating | 100 g/m² | 100 g/m² | 12 μm PET | 120 μm polyolefinically |
| | | | | | | (PE) coated paper, |
| | | | | | | siliconized on both sides |
| B | ESH | Hotmelt coating | 50 g/m² | 50 g/m² | ″ | 120 μm polyolefinically |
| | | | | | | (PE) coated paper, |
| | | | | | | siliconized on both sides |
| C | ESH | Hotmelt coating | 100 g/m² | x | ″ | 100 μm glassine release |
| | | | (coated on one | | | paper, siliconized on one |
| | | | side) | | | side |
| D | UV | Hotmelt coating | 100 g/m² | 100 g/m² | ″ | 120 μm polyolefinically |
| | | | | | | (PE) coated paper, |
| | | | | | | siliconized on both sides |
| E | UV | Hotmelt coating | 50 g/m² | 50 g/m² | ″ | 120 μm polyolefinically |
| | | | | | | (PE) coated paper, |
| | | | | | | siliconized on both sides |
| F | ESH | Hotmelt coating | 100 g/m² | 100 g/m² | 12 μm PET | 120 μm polyolefinically |
| | | | | | | (PE) coated paper, |
| | | | | | | siliconized on both sides |
| G | ESH | Hotmelt coating | 50 g/m² | 50 g/m² | ″ | 120 μm polyolefinically |
| | | | | | | (PE) coated paper |
| | | | | | | siliconized on both sides |
| H | ESH | Hotmelt coating | 100 g/m² | x | ″ | 100 μm glassine release |
| | | | (coated on one | | | paper, siliconized on one |
| | | | side) | | | side |
| I | UV | Hotmelt coating | 50 g/m² | 50 g/m² | ″ | 120 μm polyolefinically |
| | | | | | | (PE) coated paper, |
| | | | | | | siliconized on both sides |
| J | ESH | Hotmelt coating | 100 g/m² | 100 g/m² | 12 μm PET | 120 μm polyolefinically |
| | | | | | | (PE) coated paper, |
| | | | | | | siliconized on both sides |
| K | ESH | Hotmelt coating | 50 g/m² | 50 g/m² | ″ | 120 μm polyolefinically |
| | | | | | | (PE) coated paper, |
| | | | | | | siliconized on both sides |
| L | ESH | Hotmelt coating | 100 g/m² | x | ″ | 120 μm polyolefinically |
| | | | (coated on one | | | (PE) coated paper, |
| | | | side) | | | siliconized on both sides |
| M | ESH | Solvent coating | 100 g/m² | 100 g/m² | 12 μm PET | 120 μm polyolefinically |
| | | | | | | (PE) coated paper, |
| | | | | | | siliconized on both sides |
| N | ESH | Solvent coating | 50 g/m² | 50 g/m² | ″ | 120 μm polyolefinically |
| | | | | | | (PE) coated paper, |
| | | | | | | siliconized on both sides |
| O | ESH | Solvent coating | 100 g/m² | x | ″ | 100 μm glassine release |
| | | | (coated on one | | | paper, siliconized on one |
| | | | side) | | | side |
| P | ESH | Solvent coating | 100 g/m² | 100 g/m² | 12 μm PET | 120 μm polyolefinically |
| | | | | | | (PE) coated paper, |
| | | | | | | siliconized on both sides |
| R | ESH | Solvent coating | 50 g/m² | 50 g/m² | ″ | 120 μm polyolefinically |
| | | | | | | (PE) coated paper, |
| | | | | | | siliconized on both sides |
| S | ESH | Solvent coating | 100 g/m² | x | ″ | 100 μm glassine release |
| | | | (coated on one | | | paper, siliconized on one |
| | | | side) | | | side |
| T | ESH | Solvent coating | 100 g/m² | 100 g/m² | 12 μm PET | 120 μm polyolefinically |
| | | | | | | (PE) coated paper, |
| | | | | | | siliconized on both sides |
| U | ESH | Solvent coating | 50 g/m² | 50 g/m² | ″ | 120 μm polyolefinically |
| | | | | | | (PE) coated paper, |
| | | | | | | siliconized on both sides |
| V | ESH | Solvent coating | 100 g/m² | x | ″ | 100 μm glassine release |
| | | | (coated on one | | | paper, siliconized on one |
| | | | side) | | | side |

TABLE 3
Criteria for assessing the frequency of errors during the
punching experiments.

| Error rate | Evaluation |
|---|---|
| 0% | The lattice matrix was removable without problems. In |
| | punching experiments over 250 linear meters there was not |
| | a single error, i.e., no punched product was removed as well |
| | during the matrix stripping process. |
| 1-99% | Percentage of errors (missing punched products) over 250 |
| | linear meters. The error rate is based on the total number |
| | of possible punched products |
| | over 250 linear meters of the test adhesive tape. |
| 100% | The lattice matrix could not be separated from the punched |
| | products. No punched products were individualized over |
| | 250 linear meters. |

TABLE 4
Overview of the test adhesive tapes used and the punching results of
example 1. Table 3 gives an overview of the assessment criteria employed.

| Adhesive | Punching process |
|---|---|
| tape | Rotary punch with continuous matrix stripping |
| A | 0% |
| B | 0% |
| C | 0% |
| D | 0% |
| E | 0% |
| F | 0% |
| G | 0% |
| H | 0% |
| I | 0% |
| J | 0% |
| K | 0% |
| L | 0% |
| M | 18% |
| N | 5% |
| O | 9% |
| P | 56% |
| R | 34% |
| S | 22% |
| T | 84% |
| U | 65% |
| V | 40% |
| 3M 9690 ® | 54% |

TABLE 5
Overview of the test adhesive tapes used and the punching results of
example 2. The assessment criteria are shown in table 3.

| Adhesive | Punching process |
|---|---|
| tape | Rotary punch with continuous matrix stripping |
| F | 0% |
| G | 0% |
| J | 0% |
| K | 0% |
| P | 14% |
| R | 12% |
| T | 35% |
| U | 24% |

TABLE 6
Overview of the test adhesive tapes used and the punching results of
example 3. The assessment criteria are shown in table 3.

| Adhesive | Punching process |
|---|---|
| tape | Rotary punch with continuous matrix stripping |
| F | 0% |
| G | 0% |
| J | 0% |
| K | 0% |
| P | 21% |
| R | 16% |
| T | 39% |
| U | 27% |

TABLE 7
Overview of the test adhesive tapes used and the punching results of example 4. The
assessment criteria are shown in table 3.

| | Punching | |
|---|---|---|
| Adhesive tape | process | Assessment of dispensing properties |
| J | Rotary punch with | Punched products can be dispensed without |
| Hotmelt process | continuous matrix | losses over 250 linear meters |
| T | stripping | Some of the punched products cannot be |
| (Comparative specimen | | individualized. 2 cohering punched products |
| to J) | | are transferred to the substrate. |
| Solvent process | | |
| F | | Punched products can be dispensed without |
| Hotmelt process | | losses over 250 linear meters |
| P | | Some of the punched products cannot be |
| (Comparative specimen | | individualized. 2 cohering punched products |
| to F) | | are transferred to the substrate. |
| Solvent process | | |
| L | | Punched products can be dispensed without |
| Hotmelt process | | losses over 250 linear meters |
| V | | Some of the punched products cannot be |
| (Comparative specimen | | individualized. 2 cohering punched products |
| to L) | | are transferred to the substrate. |
| Solvent process | | |
| 3M 9690 | | Some of the punched products cannot be |
| | | individualized. Up to 4 cohering punched |
| | | products are transferred to the substrate. |

TABLE 8
Results relating to contamination of the punching tools.

| | | Assessment of punching tool |
|---|---|---|
| Adhesive tape | Production process | contamination |
| J | Hotmelt process | Slight contamination of the punching tools with |
| | | adhesive |
| T | Solvent process | Pronounced contamination of the punching |
| (Comparative | | tools with adhesive |
| specimen to J) | | |
| F | Hotmelt process | No contamination of the punching tools with |
| | | adhesive |
| P | Solvent process | Severe contamination of the punching tools |
| (Comparative | | with adhesive |
| specimen to F) | | |
| 3M 9690 | | Pronounced contamination of the punching |
| | | tools with adhesive |

[image]

What is claimed is:

1. A process for producing pressure-sensitively adhesive punched products from backing material coated with pressure sensitive adhesive, wherein
said pressure sensitive adhesive is oriented such that it possesses a preferential direction and,
the punching process is carried out continuously.

2. The process as claimed in claim 1, wherein the punching process takes place using a rotary punch.

3. The process as claimed in at least one of the preceding claims, wherein the oriented pressure sensitive adhesive exhibits shrinkback, the shrinkback as determined by test B (shrinkback measurement in the free film) is at least 3%.

4. The process as claimed in at least one of the preceding claims, wherein the refractive index measured in the preferential direction, n_{VR}, is greater than the refractive index measured in a direction perpendicular to the preferential direction, n_{SR}.

5. The process as claimed in claim 4, wherein the difference Δn=n_{VR}−n_{SR} is at least 1·10⁻⁵.

6. The process as claimed in at least one of the preceding claims, wherein said pressure sensitive adhesive is based on polyacrylate and/or polymethacrylate.

7. The process as claimed in at least one of the preceding claims, wherein said backing material coated with pressure sensitive adhesive is a single-sided or double-sided adhesive tape with at least one permanent backing.

8. The process as claimed in at least one of claims 1 to 6, wherein said backing material coated with pressure sensitive adhesive is a temporary support on which the material to be punched is reversibly placed.

9. The process as claimed in at least one of the preceding claims, wherein the punching process completely severs the pressure sensitive adhesive on the backing material.

10. The process as claimed in at least one of claims 1 to 8, wherein the punching process does not completely sever the pressure sensitive adhesive on the backing material.

11. The process as claimed in at least one of the preceding claims, wherein the punching process completely severs the backing material coated with pressure sensitive adhesive.

12. The process as claimed in at least one of claims 1 to 10, wherein the punching process does not sever, or only partly severs, the backing material coated with pressure sensitive adhesive.

13. A punched product obtainable by a process as claimed in at least one of the preceding claims.
